(19) United States
(12) Patent Application Publication
(10) Pub. No.: US 2014/0039969 A1
(43) Pub. Date: Feb. 6, 2014

(54) SYSTEM AND METHOD FOR INITIATING A BUSINESS EXECUTION WORKFLOW

(71) Applicants: Anil Kumar MUDDASANI, Santa Clara, CA (US); Shruti SRIVASTAVA, L. B. Shastri Nagar (IN); Murali MAZHAVANCHERY, Oakland, CA (US)

(72) Inventors: Anil Kumar MUDDASANI, Santa Clara, CA (US); Shruti SRIVASTAVA, L. B. Shastri Nagar (IN); Murali MAZHAVANCHERY, Oakland, CA (US)

(73) Assignee: SUCCESSFACTORS, INC., San Mateo, CA (US)

(21) Appl. No.: 13/564,162

(22) Filed: Aug. 1, 2012

(51) Int. Cl. G06Q 10/06

(52) U.S. Cl. 705/7.27

(57) ABSTRACT

A technique for managing changes to individual entities, such as employees, in a business execution context. When a first user, such as a manager or a human resources (HR) administrator, desires to change characteristics of an individual entity, such as an employee, the first user inputs into a software application the desired characteristic changes to be made. The software application receives the input from the first user and analyzes the information. The software application then identifies and initiates a “workflow” that corresponds to the input and effects the desired changes.

### BACKGROUND

1. Field of the Invention

The present invention generally relates to computer software and, more specifically, to a system and method for initiating a business execution workflow.

2. Description of the Related Art

Businesses constantly look for ways to effectively manage the various divisions, departments, and people in the organization using tools like spreadsheets, email, databases, and others. One challenge is to effectively manage changes to employee characteristics. For example, over time, various characteristics of employees can change, including job title, salary, location, job description, among others. Tracking these changes can be time consuming and tedious for managers and human resources (HR) administrators. Another challenge is how to correctly and effectively obtain appropriate approval for a particular change to one or more characteristics of an employee.

As the foregoing illustrates, what is needed in the art is a more effective way to manage changes in a business execution context.

### SUMMARY

One embodiment of the present invention sets forth a method for initiating a business execution workflow. The method involves receiving data associated with changes to one or more characteristics of an individual entity, analyzing the data to determine a workflow that corresponds to the changes to the one or more characteristics of the individual entity, where the workflow includes one or more steps, initiating execution of the workflow, and changing to the one or more characteristics of the individual entity after all of the one or more steps included in the workflow are completed.

Further embodiments provide a non-transitory computer-readable medium and a computer system to carry out the method set forth above.

### BRIEF DESCRIPTION OF THE DRAWINGS

So that the manner in which the above recited features of the present invention can be understood in detail, a more particular description of the present invention, briefly summarized above, may be had by reference to embodiments, some of which are illustrated in the appended drawings. It is to be noted, however, that the appended drawings illustrate only typical embodiments of the present invention and are therefore not to be considered limiting of its scope, for the present invention may admit to other equally effective embodiments.

FIG. 1 illustrates a computer system configured to implement one or more aspects of one or more embodiments.

FIG. 2 is conceptual diagram of a portion of an organizational hierarchy of an organization, according to one embodiment.

FIG. 3 is a table illustrating entities in an organization and corresponding characteristics of the entities, according to one embodiment.

FIG. 4A is a conceptual diagram illustrating rules that initiate a particular workflow, according to one embodiment.

FIG. 4B is a conceptual diagram illustrating steps of an example workflow, according to one embodiment.

FIG. 4C depicts a conceptual diagram of a user interface for initiating a particular workflow, according to one embodiment.

FIG. 5 is a flow diagram of method steps for initiating a business execution workflow, according to one embodiment.

### DETAILED DESCRIPTION

In the following description, numerous specific details are set forth to provide a more thorough understanding of embodiments of the invention. However, it will be apparent to one of skill in the art that embodiments may be practiced without one or more of these specific details. In other instances, well-known features have not been described in order to avoid obscuring embodiments of the present invention.

One embodiment of the invention sets forth a technique for managing changes to individual entities, such as employees, in a business execution context, e.g., changing the salary and title of an employee who receives a promotion. When a first user, such as a manager or a human resources (HR) administrator, desires to change the characteristics of an individual entity, such as an employee, the first user inputs the desired changes into a software application. For example, the first user may wish to change the job title and increase the salary of the employee. The software application receives the input from the first user and analyzes the input. The software application then identifies a “workflow” that should be initiated to effect the desired change. In one embodiment, a workflow is a series of steps that need to be completed and/or approved in order to make the desired change(s). For example, if the first user wishes to change the job title and increase the salary of a particular employee, then the software application may determine, based on the desired changes, that the appropriate workflow is a “promotion” workflow. The promotion workflow may, in one example, require the changes to be approved by the employee's manager, the employee's department head, and the HR department.

In one embodiment, once the software application determines a workflow that should be initiated based on the desired change(s), the software application automatically initiates the workflow. Continuing with the example workflow set forth above, the workflow may include three steps: approval by the manager, approval by the department head, and approval by the HR department. Accordingly, the software application first causes a message, such as an email, to be sent to the manager for authorization of the changes (i.e., the first step of the workflow). Once the manager authorizes the changes, then the software application causes a message to be sent to the employee's department head for authorization of the changes (i.e., the second step of the workflow). Once the employee's department head authorizes the changes, then the software application causes a message to be sent to the HR department for authorization of the changes (i.e., the third step of the workflow). Once all steps of the workflow are completed, the software application causes the desired changes to be made to the employee's profile. One or more individuals, such as, for example, the individual with the changed profile, the one more individuals that approved the changes, and/or the individual that requested the changes, may be notified (e.g., by email or otherwise) that the changes have been approved and that the changes have been made to the individual's profile.

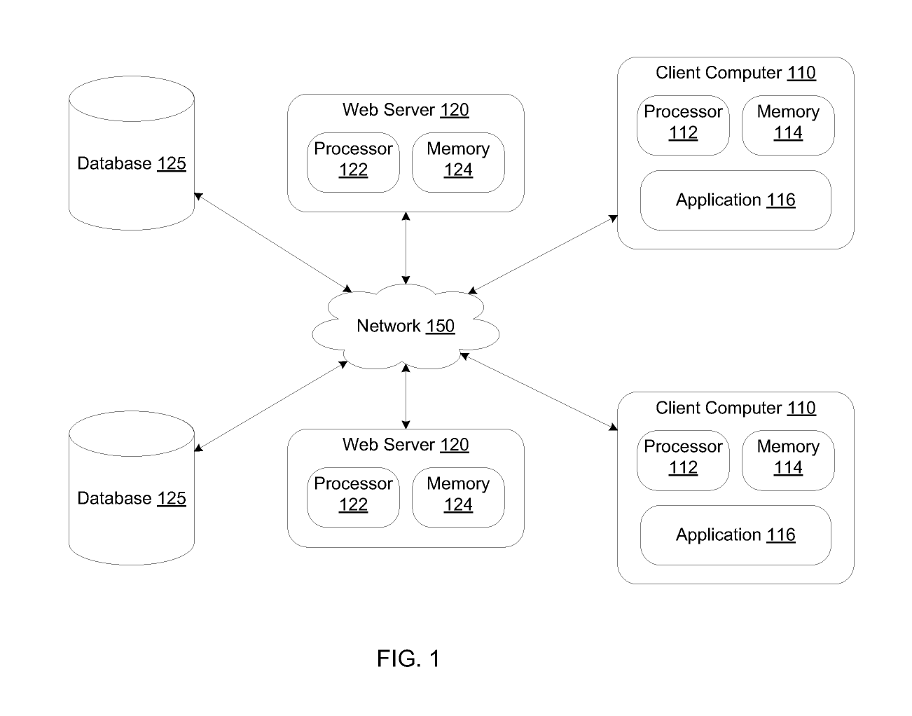

FIG. 1 illustrates a computer system configured to implement one or more aspects of one or more embodiments. As shown, the networked computer environment includes client computers 110 (only two of which are shown), web servers 120, and databases 125. The client computers 110, the web servers 120, and databases 125 are connected to one another over a computer network 150, e.g., the Internet.

Each client computer 110 includes conventional components of a computing device, e.g., a processor 112, system memory 114, a persistent storage device, input devices such as a mouse and a keyboard, and output devices such as a monitor, among others. Each web server 120 includes a processor 122 and a system memory 124. In one embodiment, each web server 120 is associated with a corresponding database 125 and manages the contents stored in the corresponding database 125. Each web server 120 is programmed to communicate with the client computers 110 and other web servers 120 via the computer network 150 using a network protocol, e.g., the TCP/IP protocol. The client computers 110 are programmed to execute web browser programs and other software applications (illustrated in FIG. 1 as application(s) 116) and access the web pages and/or applications managed by the web servers 120.

In the embodiments described below, users are manipulating and/or operating the client computers 110 that are connected to the web servers 120 over the computer network 150. In one embodiment, user interfaces in the form of web pages and/or application interfaces are transmitted from the web servers 120 to a user's client computer 110. The web pages are processed by a web browser program executing on that user's client computer 110 for display through the monitor of that user's client computer 110. In another embodiment, user interfaces are generated by the application 116 executing locally on that user's client computer 110, and the application 116 transmits data to and receives data from the web server(s) 120.

Each client computer 110 may be a personal computer, smart phone, tablet computer, or any other device suitable for practicing one or more embodiments of the present invention. It should be noted that embodiments of the present invention can be implemented in hardware, software, or in a combination of hardware and software, e.g., using application specific integrated circuits (ASIC), a general purpose computer, or any other hardware equivalents.

Some embodiments of the invention provide a software framework for making changes to a profile of an individual or other object in an organization. For example, the software framework may be configured to change an employee profile of employees at a company. Embodiments of the invention may further include a query builder that is configured to query the changes made to individual entities that satisfy certain criteria. In some embodiments, the query builder can be used for generating reports.

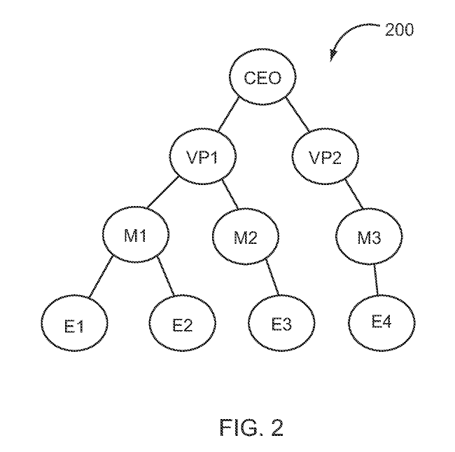

FIG. 2 is conceptual diagram of a portion of an organizational hierarchy 200 of an organization, according to one embodiment. As shown, the organizational hierarchy 200 includes a Chief Executive Officer (CEO) at the top level of the hierarchy. The next level includes two vice presidents, VP1 and VP2. Managers M1 and M2 are subordinates of vice president VP1, and manager M3 is a subordinate of vice president VP2. Employees E1 and E2 are subordinates of manager M1, employee E3 is a subordinate of manager M2, and employee E4 is a subordinate of manager M3.

Each entity (i.e., individual employee) in the organization may be associated with a profile that includes information about various characteristics of the entity. In the context of business execution, examples of characteristics include salary, title, employment location, primary manager, among others.

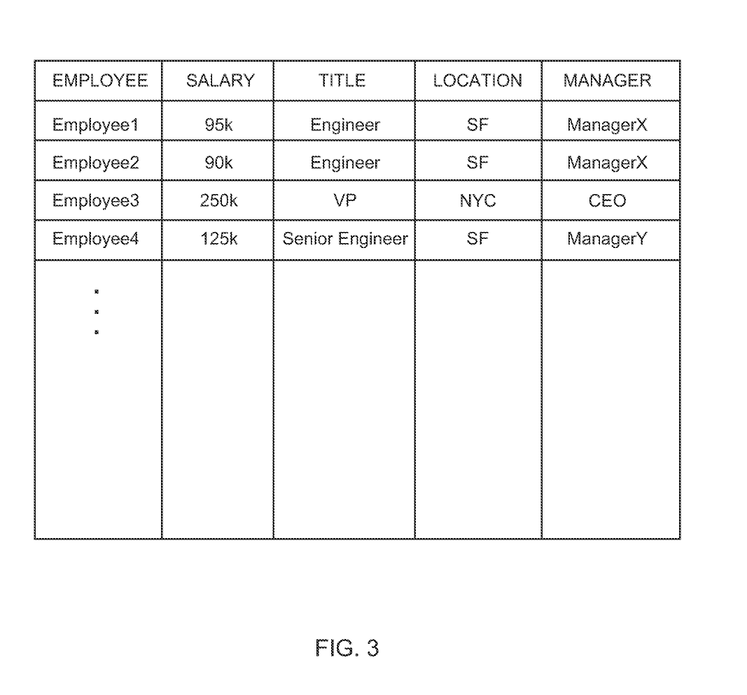

FIG. 3 is a table illustrating entities in an organization and their corresponding characteristics, according to one embodiment. In one embodiment, individual entities, such as employees at a company, are organized in a first column of the table. Additional columns in the table are associated with different characteristics for each individual entity. As shown in FIG. 3, the characteristics include salary, title, job location, and primary manager. Many other characteristics (not shown) are also with the scope of embodiments of the invention.

As described above, embodiments of the invention provide a technique whereby managers or HR administrators desire to make one or more changes to the employee profile of an employee. In order for the one or more changes to take effect, the one or more changes may need approval by one or more specific individuals. Both a particular set of changes and a particular “workflow” should be completed, e.g., in order to attain the appropriate approval. As described, in one embodiment, a workflow is a series of steps that need to be completed and/or approved in order to make the desired change(s).

A software application, such as Employee Central™ provided by SuccessFactors, Inc., may be configured to manage various aspects of employees at a company, including employee profile information and an organizational hierarchy of the company. The software application is configured with a series of business rules, such that certain changes to an employee profile and/or the organizational hierarchy of the company correspond to one or more “workflows.” When changes are requested that correspond to a particular workflow, the software application can initiate the workflow. For example, the workflow may require approval by a series of individuals. The software application is configured to automatically execute the first step of the workflow, i.e., seek approval from the first individual in the workflow. Once the software application determines that the first step is completed (i.e., the desired approval has been received), then the software application advances to the next step in the workflow. Once all of the steps in the workflow are completed, the software application causes the desired changes to be made to the entity in the organization.

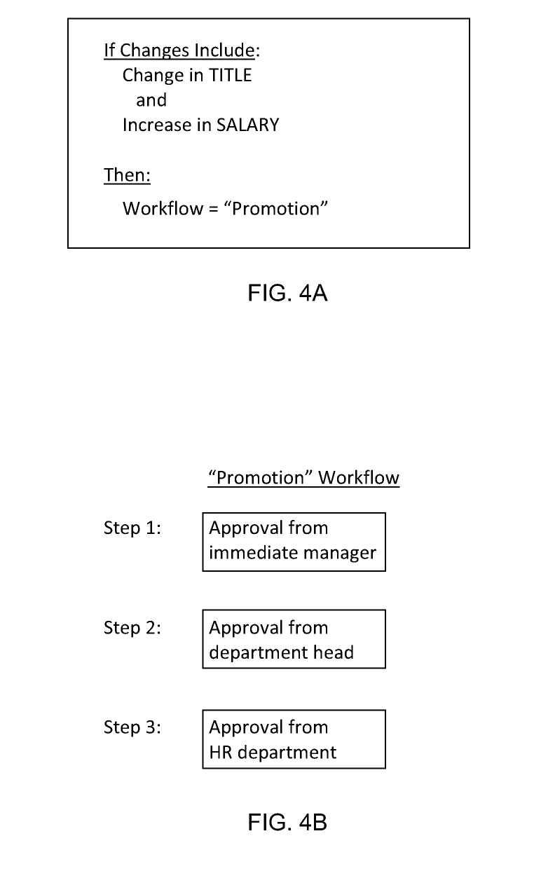

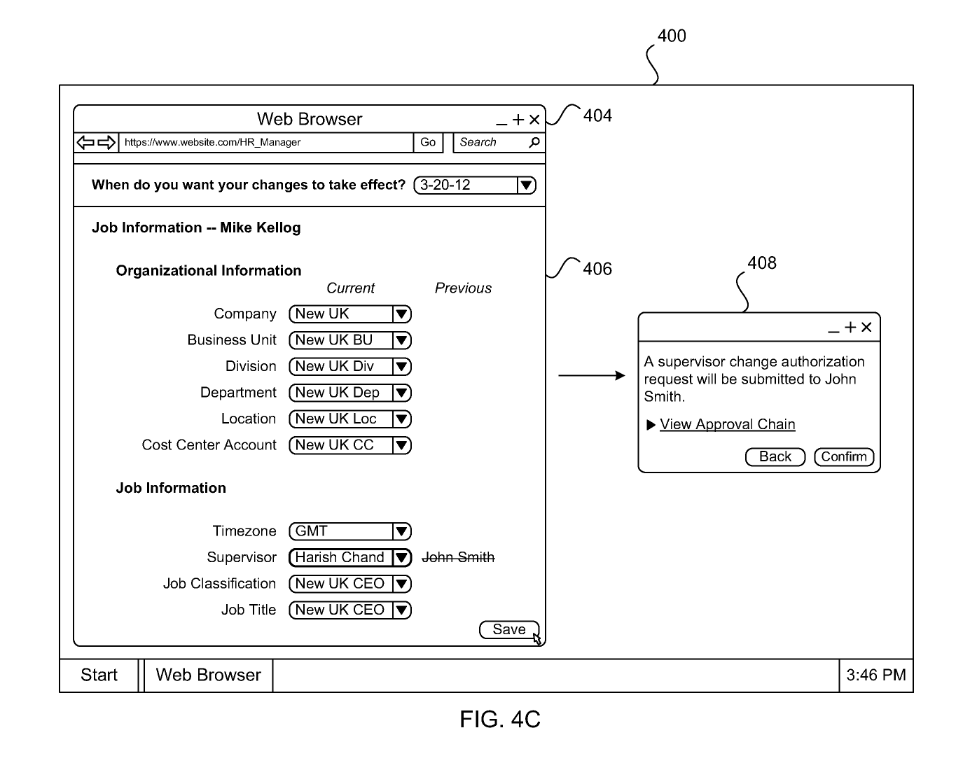

FIG. 4A is a conceptual diagram illustrating rules that initiate a particular workflow, according to one embodiment. In the example shown, if the changes include a change to both the title and salary of the employee, then a “promotion” workflow is initiated by the software application. Other examples of workflows include a demotion workflow, a relocation workflow, a department change workflow, a non-promotion job change workflow, a job change with no salary increase workflow, among others. An administrator can define custom business rules for custom workflows that fit the needs of a particular organization.

In some cases, the changes requested may satisfy the criteria for two or more different workflows. In one embodiment, each of the two or more workflows is initiated separately. In other embodiments, workflows are organized based on relative priority, and only the workflow with the highest priority is automatically initiated. In other embodiments, the user requesting the changes can choose which of the two or more workflows should be initiated.

FIG. 4B is a conceptual diagram illustrating step of an example workflow, according to one embodiment. As shown, a “promotion” workflow includes three steps: (1) approval from an immediate manager, (2) approval from a department head, and (3) approval from the HR department. After the software application has determined a particular workflow that is triggered by the requested changes, the software application can automatically initiate the workflow. According to the example shown, the software application would first perform step 1 and seek approval for the changes from the employee's immediate manager. In one embodiment, the software application can determine the particular individual who is the employee's immediate manager based on the organizational hierarchy of the company. In other embodiments, the employee's immediate manager is a data field that is part of the employee's profile and the software application can determine the employee's immediate manager by examining the employee's profile.

In one embodiment, approval from an individual is sought after by the software application by sending an email to the individual and asking the individual to approve or deny the changes. In one embodiment, the email includes hyperlinks that enable the individual to approve or deny the changes simply by clicking on the link. In other embodiments, other communication mediums can be used to seek the approval. If approval is denied, then the changes to the characteristics of the entity are not performed and the requestor may be notified that the changes will not be made.

If approval is received at the first step of the workflow, then the software application proceeds to the next step of the workflow. The software application continues to a subsequent step, if any, of the workflow once the current step is completed. Once all of the steps are completed, the changes are effected by the software application.

FIG. 4C illustrates an example user interface 400 for initiating a particular workflow, according to one embodiment. As shown, the user interface 400 includes web browser 404 displaying an example form 406 that enables an administrator to modify characteristics of an employee named Mike Kellog. In this example, the administrator updates Mike Kellog's supervisor from John Smith to Harish Chand, while leaving other characteristics unmodified. The administrator then clicks the “Save” button, which causes the software application to execute at least a workflow that is triggered based on the modifications made by the administrator.

As shown, confirmation window 408 informs the administrator that, to effect the requested changes, John Smith, the former supervisor of Mike Kellog, needs to approve Harish Chand as the new supervisor according to the techniques described herein. Confirmation window 408 also enables the administrator to view additional individuals, if any, who are required to approve the requested change. In some cases, the individuals may be sorted according to those who have authorized the request and those who have not yet viewed the request. In other cases, the individuals may be sorted hierarchically, to indicate that subordinates cannot authorize the request until their supervisor has authorized the request.

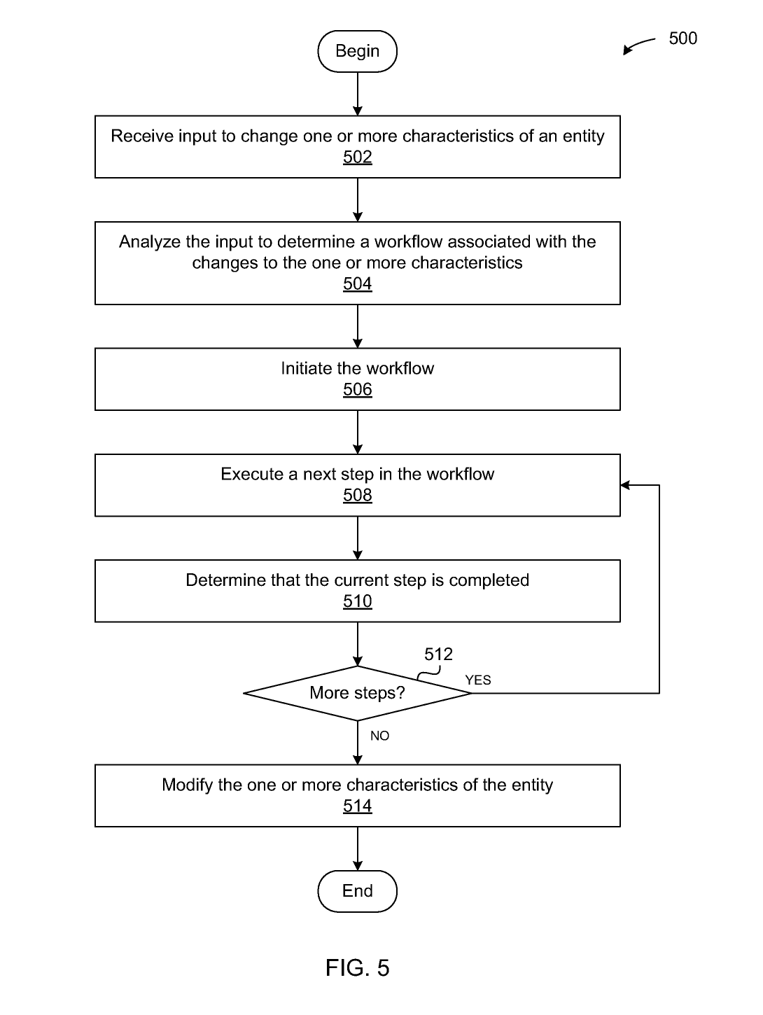

FIG. 5 is a flow diagram of method steps for initiating a business execution workflow, according to one embodiment. Although the method steps are described in conjunction with FIGS. 1-4C, persons skilled in the art will understand that any system configured to perform the method steps, in any order, is within the scope of one or more embodiments.

As shown, the method 500 begins at step 502, where a software application executing on a client computer receives input to change one or more characteristics of an entity. For example, the entity may be an employee of a corporation. In one example, the input is generated by an HR administrator.

At step 504, the software application analyzes the input to determine a workflow associated with the changes to the one or more characteristics. At step 506, the software application initiates the workflow. Initiating the workflow may be performed automatically by the software application once the software application determines the workflow at step 504.

At step 508, the software application executes a next step in the workflow. In the first instance of step 508, the “next” step corresponds to the “first” sequential step in the workflow. In one example, the software application sends an email to a particular individual requesting the individual to approve or deny the requested changes.

At step 510, the software application determines that the current step of the workflow is completed. At step 512, the software application determines whether any additional steps in the workflow have not been executed. If the software application determines that there are more steps of the workflow that have not been completed, then the method 500 returns to step 508, described above. If the software application determines that all steps in the workflow have been executed, then the method 500 proceeds to step 514.

At step 514, the software application modifies the one or more characteristics of the entity in accordance with the requested changes. In some embodiments, the software application can send a notification to indicate that the changes have been made. According to various embodiments, the notification may be sent to the individual whose characteristics have been changed, the individual that requested the changes, and/or one or more of the individuals that approved the changes during execution of the workflow.

Advantageously, embodiments of the invention provide significant enhancements that ease the administrative burden of modifying characteristics of individual entities in an organization. In the business execution context, changes may be rarely requested (e.g., on the order of once a year) and the person requesting the changes may not be familiar with the employee management application. Also, the person requesting the changes may not be familiar with the approvals that are required and/or the workflow that should be initiated from a list of possibly hundreds of different workflows. Therefore, embodiments of the invention ease this administrative burden by determining, based on the requested changes, the approvals that are required and/or the workflow that should be initiated. The workflow can then be automatically initiated, which further minimizes the burden on the person requesting the changes.

Another embodiment of the invention provides a query builder that is configured to query the changes made to individual entities that satisfy certain criteria. For example, an administrator may query the software application to identify the names and count of employees that have had a promotion and a salary increase in the past year. The software application can examine its data log to determine the results of the query and return the results to the administrator.

The query feature can be used for generating more accurate reports, as compared to prior art techniques. In the prior art, administrators would need to sift through various documents and ledgers to determine the names and count of, for example, the employees that had a promotion and a salary increase in the past year. Using the query feature, the administrators can quickly obtain this information.

In addition, the query feature provides more accurate results. In the prior art, “false positive” results may indicate inaccurate information. For example, if the administrator is seeking to determine the names and count of the employees that had a promotion and a salary increase in the past year, manually searching may incorrectly return results of employees that had a promotion but did not have a salary increase. Using the query feature, the administrators can more achieve more accurate results since incomplete or partially inaccurate results would not be returned.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

1. A method for initiating a business execution workflow, comprising:
receiving, by a computer system, data associated with changes to one or more characteristics of an individual entity;
analyzing, by the computer system, the data to determine a workflow that corresponds to the changes to the one or more characteristics of the individual entity, wherein the workflow includes one or more steps;
initiating, by the computer system execution of the workflow; and
changing, by the computer system, to the one or more characteristics of the individual entity after each of the one or more steps included in the workflow are completed.

2. The method of claim 1, wherein the changes to the one or more characteristics of the individual entity comprise changes to profile information associated with the individual entity.

3. The method of claim 1, wherein at least one step included in the workflow is associated with obtaining approval for the changes to the one or more characteristics of the individual entity.

4. The method of claim 3, wherein the individual entity is an employee at a company and the approval is obtained from a manager of the employee.

5. The method of claim 4, further comprising determining, by the computer system, the manager of the employee based on a hierarchical organization of the company.

6. The method of claim 4, wherein the approval is indicated in an email sent by the manager of the employee.

7. The method of claim 1, further comprising:
performing, by the computer system a first step of the workflow; and
when the first step of the workflow is completed, performing, by the computer system, a second step of the workflow.

8. The method of claim 1, wherein initiating execution of the workflow occurs without any user interaction besides inputting the data associated with the changes to the one or more characteristics of the individual entity.

9. The method of claim 1, wherein the workflow comprises a promotion workflow, a demotion workflow, a relocation workflow, and/or a department change workflow.

10. A non-transitory computer-readable medium storing instructions that, when executed by a processor, cause a computer system to initiate a business execution workflow, by performing the steps of:
receiving data associated with changes to one or more characteristics of an individual entity;
analyzing the data to determine a workflow that corresponds to the changes to the one or more characteristics of the individual entity, wherein the workflow includes one or more steps;
initiating execution of the workflow; and
changing to the one or more characteristics of the individual entity after each of the one or more steps included in the workflow are completed.

11. The non-transitory computer-readable medium of claim 10, wherein the changes to the one or more characteristics of the individual entity comprise changes to profile information associated with the individual entity.

12. The non-transitory computer-readable medium of claim 10, wherein at least one step included in the workflow is associated with obtaining approval for the changes to the one or more characteristics of the individual entity.

13. The non-transitory computer-readable medium of claim 12, wherein the individual entity is an employee at a company and the approval is obtained from a manager of the employee.

14. The non-transitory computer-readable medium of claim 13, further comprising determining the manager of the employee based on a hierarchical organization of the company.

15. The non-transitory computer-readable medium of claim 13, wherein the approval is indicated in an email sent by the manager of the employee.

16. The non-transitory computer-readable medium of claim 10, further comprising:
performing a first step of the workflow; and
when the first step of the workflow is completed, performing a second step of the workflow.

17. The non-transitory computer-readable medium of claim 10, wherein initiating execution of the workflow occurs without any user interaction besides inputting the data associated with the changes to the one or more characteristics of the individual entity.

18. The non-transitory computer-readable medium of claim 10, wherein the workflow comprises a promotion workflow, a demotion workflow, a relocation workflow, and/or a department change workflow.

19. A computer system, comprising:
a processor; and
a memory storing instructions that, when executed by the processor, cause the computer system to initiate a business execution workflow, by performing the steps of:
receiving data associated with changes to one or more characteristics of an individual entity;
analyzing the data to determine a workflow that corresponds to the changes to the one or more characteristics of the individual entity, wherein the workflow includes one or more steps;
initiating execution of the workflow; and
changing to the one or more characteristics of the individual entity after each of the one or more steps included in the workflow are completed.

20. The system of claim 19, wherein the changes to the one or more characteristics of the individual entity comprise changes to profile information associated with the individual entity.
